(19) United States
(12) Patent Application Publication
(10) Pub. No.: US 2004/0058133 A1
(43) Pub. Date: Mar. 25, 2004

(54) Labeling method employing two-part curable adhesives

(76) Inventor: Wayne L. Bilodeau, Mentor, OH (US)

Correspondence Address: William C. Tritt, Renner, Otto, Boisselle & Sklar, LLP, Nineteenth Floor, 1621 Euclid Avenue, Cleveland, OH, 44115-2191, US

(21) Appl. No.: 10/615,808

(22) Filed: Jul. 9, 2003

Related U.S. Application Data
(60) Provisional application No. 60/397,343, filed on Jul. 19, 2002.

(51) Int. Cl. B32B 7/12

(52) U.S. Cl. 428/195.1; 428/354

(57) ABSTRACT

In one embodiment, the present invention relates to a label including: (A) a polymer facestock having an upper surface and a lower surface; and (B) an adhesive layer derived from at least one two-part, high solids curable adhesive overlying the lower surface of the polymer facestock. The present invention further relates to a labeling process, including steps of (A) providing a substrate; (B) coating a two-part curable adhesive to one surface of a polymeric facestock; and (C) applying the adhesive coated surface fo the polymeric facestock to the substrate. The invention also relates to substrates adhered to the label and methods of labeling the substrate. The labels may be applied at ambient or cold temperatures. They can be applied to the substrate even though the substrate has moisture on its surface. The labels adhere to the substrates without the need for externally applied curing means such as radiation.

### CROSS REFERENCE TO RELATED APPLICATION

This application claims priority from provisional application 60/397,343 filed Jul. 19, 2002. The provisional application is hereby incorporated by reference in its entirety.

### TECHNICAL FIELD OF THE INVENTION

This invention relates to labels, and more particularly to polymeric film labels, substrates adhered to the labels and to a process of applying polymeric film labels to containers.

### BACKGROUND OF THE INVENTION

It is common practice to apply labels to substrates such as containers or bottles formed from polymers or glass. Such containers and bottles are available in a wide variety of shapes and sizes for holding many different types of materials such as detergents, chemicals, motor oil, soft drinks, alcoholic beverages, etc. The labels provide information containing the contents of the container and other information such as the supplier of the container or the contents of the container.

One widely used and well known labeling technique uses a water-based adhesive, and this technique is commonly known as water-based “cold glue labeling” or “patch labeling”. The water-based cold glue suffices when the linerless label is paper. With paper label substrates, clarity of the glue is not important and paper provides a mechanism for water-removal to set the adhesive. In such labeling method, a water-based adhesive is applied to the label, which is usually held in a stack in a magazine, the label is then transferred to a transfer means, and the label is subsequently applied to the relevant container. The use of water-based adhesives results in a problem that, when the substrate is, for example, a beverage container, and is placed in water, such as in an ice chest, the label tends to become loose and fall off the container, since the water based adhesive is water labile. In addition, the water-based adhesive presents a problem when polymeric film label substrates are used since the film provides no mechanism for water removal. The cold glues are not optically clear. The use of water-based or water-labile adhesives results in this problem, which has been long-standing in the industry. The problem occurs for both paper and polymer labels, when the adhesive used is water-labile.

Thus, there is a need in the art to provide a system that is compatible with high speed bottle labeling equipment when film labels are applied. In addition, if clear film labels are used the adhesive must be clear as well. To address these short-comings, the Dronzek patent (U.S. Pat. No. 6,306,242) teaches the use of film labels with “hydrophillic layers” to provide a mechanism of water removal when water-based adhesives are used. However, such water removal mechanism require time for the water to diffuse out of the adhesive layer, and there remains the issue of adhesive clarity when clear film facestocks are used. Such labels and adhesives generally fail to provide adequate ice chest performance, i.e., when the labeled container is placed in an ice chest containing a mixture of ice and water, the adhesive is weakened and usually fails due to the excessive amount of water in which it is held. Due to the time required for the water to diffuse outward, bottle line speeds may by slowed from optimum speeds due to the difference between the water-removal mechanism of “hydrophillic layers” and that of porous paper based labels.

To address some of the issues remaining from the Dronzek system, the recent application by Applied Extrusion Technologies (U.S. Patent Application Publication No. 2002/0000293 A1) provides some advantages over Dronzek in that a method is taught using UV curable clear adhesives. However, this system requires modification of equipment and slowing of the bottling line to provide for and allow the UV curing.

One approach to addressing this problem has been to use radiation-curable polymeric adhesives. However, the use of radiation-curable adhesives requires the addition of radiation curing apparatus to existing labeling equipment, including not only the radiation sources, but also shields to protect workers from stray radiation. Another significant drawback to the use of such systems is the time required to achieve a cure, which results in a reduction in label-application rate, and thereby a reduction in the rate at which labeled containers can be processed. For example, it is usual in modern beverage-container filling to process 1000 bottles per minute using standard, water-based adhesives. The use of radiation-curable adhesives reduces the maximum rate to 600 bottles per minute or less.

An additional problem which primarily affects polymer labels used with a solvent- or water-based adhesive, whether or not radiation curable, is the need to manage the solvent or water from the adhesive following application of the adhesive to the label and the label with adhesive to the substrate. Since polymer labels are relatively non-porous and generally have a much lower moisture vapor transmission rate (MVTR) than paper labels, the polymer labels have a tendency to “swim” or float on the adhesive after the label with adhesive is applied to the substrate, during the time from application until removal of enough of the solvent or water to increase the viscosity of the adhesive for the label to remain in position.

Accordingly, it would be desirable to produce labels which can be applied to containers using a curable adhesive wherein the adhesive cures and the label bonds to the container within an acceptable period of time, even when the container is cold and without addition of radiation curing apparatus to the standard label-application apparatus.

### SUMMARY OF THE EMBODIMENTS

In one embodiment, the present invention relates to a label including: (A) a polymer facestock having an upper surface and a lower surface; and (B) an adhesive layer derived from at least one two-part, high solids curable adhesive overlying the lower surface of the polymer facestock. In another embodiment, the present invention relates to a label including: (A) a polymer facestock having an upper surface and a lower surface, wherein the polymer facestock is a biaxially oriented polyethylene terephthalate or polypropylene; and (B) an adhesive layer is derived from a high solids adhesive comprising (a) an epoxy resin and a primary amine, a carboxylic acid or a carboxylic anhydride or a mixture of two or more thereof; (b) a cyclic anhydride and a primary amine; (c) an oxazoline and a primary amine, a carboxylic acid or a carboxylic anhydride or a mixture of two or more thereof; (d) a carbodiimide and primary amine or a carboxylic acid; or (e) an isocyanate and a primary amine, an alcohol or a carboxylic acid, or a mixture of two or more thereof; or a mixture of two or more of (a)-(e). The present invention further relates to a labeling process, including steps of (A) providing a substrate; (B) coating a two-part curable adhesive to one surface of a polymeric facestock; and (C) applying the adhesive coated surface fo the polymeric facestock to the substrate. The invention also relates to substrates adhered to the label and methods of labeling the substrate. The labels may be applied at ambient or cold temperatures. They can be applied to the substrate even though the substrate has moisture on its surface. The labels adhere to the substrates without the need for externally applied curing means such as radiation.

### BRIEF DESCRIPTION OF THE DRAWINGS

FIGS. 1-6 are cross sections of label constructions of the present invention.

It should be appreciated that for simplicity and clarity of illustration, elements shown in the figures have not necessarily been drawn to scale. For example, some dimensions of some of the elements may be exaggerated relative to each other for clarity. Further, where considered appropriate, reference numerals have been repeated among the figures to indicate corresponding or same elements.

### DESCRIPTION OF THE INVENTION

The term “overlies” and cognate terms such as overlying and the like, when referring to the relationship of one or a first layer relative to another or a second layer, refers to the fact that the first layer is applied to partially or completely covers the second layer. The first layer overlying the second layer may or may not be in contact with the second layer. For example, one or more additional layers may be positioned between the first and the second layer. The term “underlies” and cognate terms such as “underlying” and the like have similar meanings except that the first layer partially or completely lies under, rather than over, the second layer.

The term “transparent” when referring to one or more layers of the label film means that any ink or print layer beneath such layers can be seen through such layers.

All range and ratio limits disclosed in the specification and claims may be combined. It is to be understood that unless specifically so specified, references to “a”, “an”, “the” may include one or more than one, and that any reference to an item in the singular may also include the item in the plural.

In a first embodiment (hereinafter sometimes referred to as “the label of the first embodiment”), the present invention relates to a label including: (A) a polymer facestock having an upper surface and a lower surface; and (B) an adhesive layer comprising at least one two-part curable adhesive overlying the lower surface of the polymer facestock. In embodiments of the present invention, the two-part, curable adhesive may comprise adducts of one or more of (a) epoxy+primary amine, carboxylic acid or cyclic anhydride; (b) cyclic anhydride+primary amine; (c) oxazoline+primary amine, carboxylic acid or anhydride; (d) carbodiimide+primary amine or carboxylic acid; (e) isocyanate+primary amine, alcohol or carboxylic acid.

### Polymer Facestokes

The present invention comprises (A) a polymer facestock. A wide variety of polymer film materials are useful in preparing the facestocks useful in the present invention. For example, the polymer film material may include homopolymers, copolymers or terpolymers.

The polymer facestock material is chosen to provide a continuous polymer film in the film structures of this invention with the desired properties such as improved tensile strength, elongation, impact strength, tear resistance, and optics (haze and gloss). The choice of polymer facestock forming material also is determined by its physical properties such as melt viscosity, high speed tensile strength, percent elongation etc.

The thickness of the polymer facestock is from about 0.1 to about 10 mils, or from about 1 to about 5 mils, or from about 1 to about 3 mils. The polymer facestock may comprise a single layer, or the film can be a multilayer film of two or more adjacent layers. For example the film can comprise one layer of a polyolefin (e.g., a poly-α-olefin) and one layer of a blend of a polyolefin (or poly-α-olefin) and a copolymer of ethylene and vinyl acetate (EVA). In another embodiment the film comprises three layers, a base or core layer of, for example, a polyolefin, and skin layers in both sides of the base or core layer which may be comprised of the same or different polymer blends. The individual layers of a multilayer polymer facestock may be selected to provide desirable properties.

In one embodiment, the polymer facestocks used in the present invention are not oriented. That is, the polymer facestock and films are not subjected to a hot-stretching and annealing step. In other embodiments, the polymer facestock contained in the labels used in the present invention may be oriented in the machine direction (uniaxially) or in both the machine and cross directions (biaxially) by hot-stretching and annealing by techniques well known to those skilled in the art. For example, the films may be hot-stretched in the machine direction only at a ratio of at least 2:1 and more often, at a ratio of between about 2:1 to about 9:1, or from about 3: to about 8:1, or from about 4:1 to about 6.5:1. After the film has been hot stretched, it is generally passed over annealing rolls where the film is annealed or heat-set at temperatures in the range of from about 50° C., or from 100° C. to about 150° C., followed by cooling. Such orientation provides the films with properties such as increased stiffness and, in some instances, improved printability. In one embodiment, the polymer facestock is a biaxially oriented polypropylene film having a thickness of about 2.0 to 2.4 mils with a Gurley machine direction stiffness of at least 16 mg and a cross direction stiffness of at least 17 mg.

Examples of the polymers include polyolefins, polyacrylates, polystyrenes, polyamides, polyvinyl alcohols, poly(alkylene acrylate)s, poly(ethylene vinyl alcohol)s, poly(alkylene vinyl acetate)s, polyurethanes, polyacrylonitriles, polyesters, polyester copolymers, fluoropolymers, polysulfones, polycarbonates, styrene-maleic anhydride copolymers, styrene-acrylonitrile copolymers, ionomers based on sodium or zinc salts of ethylene methacrylic acid, cellulosics, alkylene-vinyl acetate copolymers, or mixtures of two or more thereof. In one embodiment, the polymer facestock is polyethylene terephthalate (PET). In one embodiment, the polymer facestock is biaxially oriented polypropylene (BOPP).

The polyolefins which can be utilized as the polymer film material include polymers and copolymers of olefin monomers containing 2 to about 12 carbon atoms such as ethylene, propylene, 1-butene, etc., or blends of mixtures of such polymers and copolymers. In one embodiment the polyolefins comprise polymers and copolymers of ethylene and propylene. In another embodiment, the polyolefins comprise propylene homopolymers, and copolymers such as propylene-ethylene and propylene-1-butene copolymers. Blends of polypropylene and polyethylene with each other, or blends of either or both of them with polypropylene-polyethylene copolymer also are useful. In another embodiment, the polyolefin film materials are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content.

Various polyethylenes can be utilized as the polymer film material including low, medium, and high density polyethylenes, and mixtures thereof. An example of a useful low density polyethylene (LDPE) is REXENE® 1017 available from Huntsman. An example of a useful high density polyethylene (HDPE) is FORMOLINE® LH5206 available from Formosa Plastics. In one embodiment the polymer film material comprises a blend of 80 to 90% HDPE and 10-20% of LDPE.

The propylene homopolymers which can be utilized as the polymer film material in the invention, either alone, or in combination with a propylene copolymer as described herein, include a variety of propylene homopolymers such as those having a melt flow index (MFI) from about 0.5 to about 20 as determined by ASTM Test D 1238. In one embodiment, propylene homopolymers having MFI's of less than 10, and more often from about 4 to about 10 are particularly useful. Useful propylene homopolymers also may be characterized as having densities in the range of from about 0.88 to about 0.92 g/cm³. A number of useful propylene homopolymers are available commercially from a variety of sources, and some useful polymers include: 5A97, available from Union Carbide and having a melt flow of 12.0 g/10 min and a density of 0.90 g/cm³; DX5E66, also available from Union Carbide and having an Melt Flow Index (MFI) of 8.8 g/10 min and a density of 0.90 g/cm³; and WRD5-1057 from Union Carbide having an MFI of 3.9 g/10 min and a density of 0.90 g/cm³. Useful commercial propylene homopolymers are also available from Fina and Montel.

Examples of useful polyamide resins include resins available from EMS American Grilon Inc., Sumter, S.C., under the general tradenames GRIVORY® and GRILON®, such as CF6S, CR-9, XE3303 and G-21. GRIVORY® G-21 is an amorphous nylon copolymer having a glass transition temperature of 125° C., a melt flow index (DIN 53735) of 90 ml/10 min and an elongation at break (ASTM D638) of 15. GRIVORY® CF65 is a nylon 6/12 film grade resin having a melting point of 135° C., a melt flow index of 50 ml/10 min, and an elongation at break in excess of 350%. GRILON® CR9 is another nylon 6/12 film grade resin having a melting point of 200° C., a melt flow index of 200 ml/10 min, and an elongation at break at 250%. GRILON® XE 3303 is a nylon 6.6/6.10 film grade resin having a melting point of 200° C., a melt flow index of 60 ml/10 min, and an elongation at break of 100%. Other useful polyamide resins include those commercially available from, for example, Arizona Chemical Co., Panama City, Fla. under the UNI-REZ® product line, and dimer-based polyamide resins available from Bostik, Emery, Fuller, Henkel (under the VERSAMID® product line). Other suitable polyamides include those produced by condensing dimerized vegetable acids with hexamethylene diamine. Examples of polyamides available from Arizona Chemical include UNI-REZ® 2665; UNI-REZ® 2620; UNI-REZ® 2623; and UNI-REZ® 2695.

Polystyrenes can also be utilized as the polymer facestock material and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillips Petroleum Co. KR-10 is believed to be a copolymer of styrene with 1,3-butadiene.

Polyurethanes also can be utilized as the polymer film material, and the polyurethanes may include aliphatic as well as aromatic polyurethanes.

The polyurethanes are typically the reaction products of (A) a polyisocyanate having at least two isocyanate (—NCO) functionalities per molecule with (B) at least one isocyanate reactive group such as a polyol having at least two hydroxy groups or an amine. Suitable polyisocyanates include diisocyanate monomers, and oligomers.

Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of commercial polyurethanes include SANCURE® 2710 and/or AVALURE® UR 445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), SANCURE® 878, SANCURE® 815, SANCURE® 1301, SANCURE® 2715, SANCURE® 1828, SANCURE® 2026, and SANCURE® 12471 (all of which are commercially available from B.F. Goodrich, Cleveland, Ohio), BAYHYDROL® DLN (commercially available from Bayer Corp., McMurray, Pa.), BAYHYDROL® LS-2033 (Bayer Corp.), BAYHYDROL® 123 (Bayer Corp.), BAYHYDROL® PU402A (Bayer Corp.), BAYHYDROL® 110 (Bayer Corp.), WITCOBOND® W-320 (commercially available from Witco Performance Chemicals), WITCOBOND® W-242 (Witco Performance Chemicals), WITCOBOND® W-160 (Witco Performance Chemicals), WITCOBOND® W-612 (Witco Performance Chemicals), WITCOBOND® W-506 (Witco Performance Chemicals), NEOREZ® R-600 (a polytetramethylene ether urethane extended with isophorone diamine commercially available from Avecia, formerly Avecia Resins), NEOREZ® R-940 (Avecia Resins), and NEOREZ® R-960 (Avecia Resins).

Examples of such aliphatic polyether polyurethanes include SANCURE® 2710 and/or Avalure UR 4457, SANCURE® 878, NEOREZ® R-600, NEOREZ® R-966, NEOREZ® R-967, and WITCOBOND® W-320.

In one embodiment, the polymer facestocks comprises at least one polyester polyurethane. Examples of these urethanes include those sold under the names “SANCURE® 2060” (polyester-polyurethane), “SANCURE® 2255” (polyester-polyurethane), “SANCURE® 815” (polyester-polyurethane), “SANCURE® 878” (polyether-polyurethane) and “SANCURE® 861” (polyether-polyurethane) by the company Sanncor, under the names “NEOREZ® R-974” (polyester-polyurethane), “NEOREZ® R-981” (polyester-polyurethane) and “NEOREZ® R-970” (polyether-polyurethane) by the company ICI, and the acrylic copolymer dispersion sold under the name “NEOCRYL® XK-90” by the company Avecia.

Polyesters prepared from various glycols or polyols and one or more aliphatic or aromatic carboxylic acids also are useful film materials. Polyethylene terephthalate (PET) and PETG (PET modified with cyclohexanedimethanol) are useful film forming materials which are available from a variety of commercial sources including Eastman. For example, KODAR® 6763 is a PETG available from Eastman Chemical. Another useful polyester from DuPont is SELAR® PT-8307 which is polyethylene terephthalate.

Acrylate polymers and copolymers and alkylene vinyl acetate resins (e.g., EVA polymers) also are useful as the film forming materials in the preparation of the constructions of the invention. Commercial examples of available polymers include ESCORENE® UL-7520 (Exxon), a copolymer of ethylene with 19.3% vinyl acetate; NUCRELL® 699 (DuPont), an ethylene copolymer containing 11% of methacrylic acid, etc.

Ionomers (polyolefins containing ionic bonding of molecular chains) also are useful. Examples of ionomers include ionomeric ethylene copolymers such as SURLYN® 1706 (DuPont) which is believed to contain interchain ionic bonds based on a zinc salt of ethylene methacrylic acid copolymer. SURLYN® 1702 from DuPont also is a useful ionomer.

Polycarbonates also are useful, and these are available from the Dow Chemical Co. (CALIBRE®) G.E. Plastics (LEXAN®) and Bayer (MAKROLON®). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range of from 4 to 22 g/10 min.

In one embodiment, the polymer facestock material may comprise a fluorinated polymer. The fluorinated polymer includes a thermoplastic fluorocarbon such as polyvinylidene fluoride (PVDF). The fluorinated polymer also can include copolymers and terpolymers of vinylidene fluoride. A useful thermoplastic fluorocarbon is the polyvinylidene fluoride known as KYNAR®, a trademark of Pennwalt Corp. This polymer is a high molecular weight (400,000) polymer which provides a useful blend of durability and chemical resistance properties. Generally, a high molecular weight PVDF resin, with a weight average molecular weight of about 200,000 to about 600,000 is used.

The polymer facestock material may be free of inorganic fillers and/or pigments for clear facestocks and clear labels, or the polymer facestock material may contain inorganic fillers and other organic or inorganic additives to provide desired properties such as appearance properties (opaque or colored films), durability and processing characteristics. Nucleating agents can be added to increase crystallinity and thereby increase stiffness. Examples of useful materials include calcium carbonate, titanium dioxide, metal particles, fibers, flame retardants, antioxidant compounds, heat stabilizers, light stabilizers, ultraviolet light stabilizers, antiblocking agents, processing aids, acid acceptors, etc.

The polymer facestocks useful in the labels can be manufactured by those processes known to those skilled in the art such as by casting or extrusion. In one embodiment, the films are manufactured by polymer extrusion or coextrusion processes. The extrudate or coextrudate of polymeric film materials is formed by simultaneous extrusion from a suitable known type of extrusion or co-extrusion die, and in the case of a coextrudate, the layers are adhered to each other in a permanently combined state to provide a unitary coextrudate.

In addition to coextrusion, the multilayer film polymer facestocks useful in the present invention may be prepared by extrusion of a continuous film to form one layer followed by the application of one or more additional layers on the extruded layer by extrusion of one or more additional layers; by lamination of a preformed polymer film to a preformed functional film; or by deposition of additional layers on the preformed film from an emulsion or solution of a polymeric film forming material.

The surface energy of both surfaces of the polymer facestock can be enhanced by treatments such as corona discharge, flame, plasma, etc. to provide the surfaces with desirable properties such as improved adhesion to subsequently applied layers such as a print layer. Procedures for corona treating and flame treating of polymer films are well known to those skilled in the art. In one embodiment, a polymer facestock is corona discharge treated on the upper surface and in one embodiment the polymer facestock is flame treated on the lower surface. In another embodiment, the polymer facestock is corona discharge treated on one surface and flame treated on the opposite surface.

In one embodiment, the polymer facestock comprises a tie coating layer that can provide anchorage to the adhesive. In another embodiment, the polymer facestock comprises a barrier coating layer to stop adhesive components from migrating into the polymer facestock. The barrier coating layer can function as a tie layer as well to the adhesive.

### Two-part, High Solids Curable Adhesives

The present invention further comprises (B) at least one two-part curable adhesive. The two-part curable adhesive is generally present on the polymeric facestock at a coat weight of about 10 to about 50, or about 15 to about 45, or about 20 to about 40, or about 25 to about 35 grams per square meter.

In one embodiment, the two-part, curable adhesive is curable at room or ambient temperature or at lower temperatures. Room or ambient temperature is defined herein as a temperature in the range from about 10° C. to about 35° C. In one embodiment, the two-part curable adhesive is curable at temperatures at least as low as 0° C. (zero degrees Celsius).

As used herein, the term “curable at a temperature” means that the adhesive composition cures to a state at which the adherend is not substantially moveable under normal handling conditions within a period of about one hour after application of the adhesive-containing adherend to the substrate adherend. The term “curable at room temperature” means that the adhesive transforms at ambient temperature, in the absence of externally-applied energy (such as heat or actinic radiation) from a flowable, easily applied mass of adhesive, or glue, to a higher molecular-weight, dry-to-the-touch adhesive with good bonding properties over time. The curing results from chemical coupling of reactive chemical species in the adhesive including, e.g., an increase in molecular weight, producing the non-flowable and dry-to-the-touch adhesive.

In one embodiment, the two-part, curable adhesive may comprise adducts of one or more of (a) epoxy+primary amine, carboxylic acid or anhydride, or mixtures of two or more thereof; (b) cyclic anhydride+primary amine; (c) oxazoline+primary amine, carboxylic acid or anhydride, or mixtures of two or more thereof; (d) carbodiimide+primary amine or carboxylic acid, or mixtures of two or more thereof; or (e) isocyanate+primary amine, alcohol or carboxylic acid, or mixtures of two or more thereof; or mixtures of two or more of (a)-(f).

In one embodiment, the two-part, curable adhesive composition is a high solids adhesive composition. High solids refers adhesive compositions which contain greater than or equal to about 75%, or 80%, or 85%, or 90% solids. Solids are non volatile components of the adhesive. The balance of the high solids adhesive compositions are volatile components such as water or organic solvents. In one embodiment, the adhesive composition is a 100% solids composition which is defined herein as a composition containing less than about 0.1% by weight of a volatile solvent. In one embodiment, the high solids adhesive composition comprises less than about 10% by weight volatile solvent, in another embodiment, less than about 5% by weight volatile solvent, in another embodiment, less than about 2% by weight volatile solvent, in another embodiment, less than about 1% by weight volatile solvent, in another embodiment, less than about 0.1% by weight volatile solvent. In one embodiment, the curable adhesive composition is substantially free of organic solvents.

Epoxy Adhesives

In one embodiment, the two-part curable adhesive is an epoxy adhesive. The epoxy adhesive comprises an epoxy resin and a curing agent. In one embodiment, the epoxy resin has an epoxy equivalent weight in the range of from about 80 to about 1000, and in another embodiment, from about 100 to about 700, and in another embodiment from about 150 to about 250. As used herein, the phrase “epoxy equivalent weight” means the weight of resin in grams which contains one gram equivalent of epoxy.

The epoxy resins useful in the present invention include any one of a number of well-known organic resins which are characterized by the presence therein of the epoxide group. A wide variety of such resins are available commercially. In one embodiment, the resins have either a mixed aliphatic-aromatic or an exclusively non-benzenoid (i.e., aliphatic or cycloaliphatic) molecular structure.

The mixed aliphatic-aromatic epoxy resins which are useful with the present invention are prepared by the well-known reaction of a bis(hydroxy-aromatic)alkane or a tetrakis-(hydroxyaromatic)-alkane with a halogen-substituted aliphatic epoxide in the presence of a base such as, e.g., sodium hydroxide or potassium hydroxide. Under these conditions, hydrogen halide is first eliminated and the aliphatic epoxide group is coupled to the aromatic nucleus via an ether linkage. Then the epoxide groups condense with the hydroxyl groups to form polymeric molecules which vary in size according to the relative proportions of reactants and the reaction time. The following equations, using for purposes of illustration, epichlorohydrin and 2,2-bis-(p-hydroxyphenyl)propane as reactants, while not necessarily representing all reactions, are believed to represent some of the principal reactions which occur.

In lieu of the epichlorohydrin, one can use halogen-substituted aliphatic epoxides containing about 4 or more carbon atoms, generally about 4 to about 20 carbon atoms. In general, it is useful to use a chlorine substituted terminal alkylene oxide (terminal denoting that the epoxide group is on the end of the alkyl chain) and a particular preference is expressed for epichlorohydrin by reason of its commercial availability and excellence in forming epoxy resins useful for the purpose of this invention.

If desired, the halogen substituted aliphatic epoxide may also contain substituents such as, e.g., hydroxy keto, nitro, nitroso, ether, sulfide, carboalkoxy, etc. Similarly, in lieu of the 2,2-bis-(p-hydroxy-phenyl)-propane, one can use bis-(hydroxyaromatic) alkanes containing about 16 or more carbon atoms, generally about 16 to about 30 carbon atoms such as, e.g., 2,2-bis-(1-hydroxy-4-naphthyl)-propane; 2,2-bis-(o-hydroxyphenyl)propane; 2,2-bis-(p-hydroxyphenyl) butane, 3,3-bis-p-hydroxyphenyl)hexane; 2-(p-hydroxy-phenyl)-4-(1-hydroxy-4-naphthyl) octane, 5-5-bis-(p-hydroxy-o-methylphenyl)decane, bis-(p-hydroxy-phenyl)methane, 2,2-bis-(p-hydroxy-o-isopropyl-phenyl)propane, 2,2-bis-(o,p-dihydroxyphenyl)propane, 2-(p-hydroxyphenyl)-5-(o-hydroxyphenyl)hexadecane, and the like. If desired, the bis-(hydroxyaromatic)alkane may contain substituents such as, e.g., halogen, nitro, nitroso, ether, sulfide, carboalkoxy, etc. In general, bis-(p-hydroxy-phenyl)alkane compounds of this type are used as they are readily available from the well-known condensation of phenols with aliphatic ketones or aldehydes in the presence of a dehydrating agent such as sulfuric acid. Particularly useful is 2,2-bis-(p-hydroxyphenyl)propane, which is available commercially as “Bisphenol A”.

In one embodiment, the epoxy resin is a bisphenol-A type epoxy resin, a bisphenol-F type epoxy resin, a bisphenol-AD type epoxy resin, a hydrogenated epoxy resin, a novolac type epoxy resin, a (mono)glycidyl ester type epoxy resin, a polyurethane-modified epoxy resin, a nitrogen epoxy resin having epoxidized methalkylene diamine, or a rubber-modified epoxy resin containing butadiene or NBR.

Epoxy resins useful for the purpose of the present invention are prepared by the reaction of bis-(hydroxyphenyl)alkane, such as 2,2-bis-(p-hydroxyphenyl)propane with a chlorine substituted terminal alkylene oxide, for instance epichlorohydrin, to produce a product having an average molecular weight within the range of about 300 to about 500 and or about 350 to about 400. One of such epoxy resins having an average molecular weight of about 380 and prepared from 2,2-bis-(p-hydroxyphenyl) propane and epichlorohydrin is known by the trade designation “Epon 820”. A related type of epoxy resin having an average molecular weight of about 616 and prepared from epichlorohydrin and symmetrical tetrakis-(p-hydroxyphenyl) ethane is available under the trade designation “Epon 1031”.

Another general class of epoxy resins which are useful for the purpose of the present invention are the aliphatic or cycloaliphatic epoxy resins. These resins, which are cyclic or acyclic olefins such as, e.g., methylcyclohexane, vinylcyclohexene, alpha-methyl-vinylcyclohexene, polybutadiene, etc., which contain at least one carbon-to-carbon multiple bond. One of such non-benzenoid epoxy resins, known by the trade designation “Oxiron 2001”, is made by oxidizing polybutadiene with peracetic acid.

Still another class of epoxy resins which are useful for the purposes of the present invention are the novolak resins. Representative of the novolak resins are the phenol novolak and cresol novolak resins. An example of these resins is a polyglycidyl ether of a novolac phenolic or cresol resin, such as DEN 431 or DEN 438, available from Dow Chemical Company.

In one embodiment, the two-part curable adhesive comprises a modified epoxy compound, such as a polyurethane-modified, or thermoplastic-modified or a rubber-modified epoxy compound. The epoxy compound useful in the present invention is not particularly limited, any epoxy compound being within the scope of the present invention.

In one embodiment, the epoxy resin is a polyurethane modified epoxy resin. In one embodiment, the polyurethane modified epoxy resin is ERISYS® EMUA-11, available from CVC Specialty Chemicals, Maple Shade, N.J. ERISYS® EMUA-11 is a standard bisphenol A epoxy resin system which has been modified with a select thermoplastic polyurethane.

In another embodiment, the epoxy resin is an epoxidized cyclohexane dimethanol modified with an elastomer. In one embodiment, the epoxidized cyclohexane dimethanol is modified with a carboxyl-terminated butadiene/acrylonitrile (CTBN) elastomer rubber. The CTBN elastomer rubber, and is ERISYS® EMRM-22, available from CVC Specialty Chemicals, Maple Shade, N.J. ERISYS® EMRM-22 is a diepoxide functional polymer of cyclohexane dimethanol and a liquid butadiene-acrylonitrile CTBN rubber.

The polyurethane or elastomeric component flexibilizes the epoxy resin and allows it to remain flexible, or to not become brittle and easily separated from the substrate, down to temperatures to which the labeled substrate may be subjected, e.g., in an ice/water mixture in an ice chest.

In one embodiment, the epoxy resins is a polyglycidyl ether of an aromatic polyol or an aliphatic polyol that has from about 6 to about 100 carbon atoms. In one embodiment, the polyol has from about 10 to about 60 carbon atoms. Representative epoxy functionalized compounds include the diglycidyl ether of bisphenol-A, and a polyglycidyl ether of an aliphatic polyol having from about 4 to about 10 carbon atoms, as for example, neopentyl diglycidyl ether (ERISYS GE-20) or cyclohexanedimethanol diglycidyl ether (ERISYS GE-22), available from CVC Specialty Chemicals, Inc. The epoxy compounds may also be a cycloaliphatic compound of from 6 to 20 carbon atoms, such as ERL 4221 (available from Union Carbide Co.)

As described herein, the epoxy adhesive comprises one or more of the above described epoxy resins and one or more curing agents. Curing agents also have been referred to as curative agents. Various compounds have been used as curing agents for epoxy resins, including both catalytic and co-reactive types. The catalytic type include Lewis acids or bases such as the tertiary amines. The co-reactive curing agents include, for example, polyamines, polyaminoamides, polyphenols, polymeric thiols, polycarboxylic acids and cyclic anhydrides, and amine/acrylate compounds (curing by Michael addition). Typical curing agents may be found in “Handbook of Thermoset Plastics” edited by Sidney H. Goodman, Noyes publications, pp. 141-157, 1986. In one embodiment, the curing agent is a carboxylic acid, a carboxylic anhydride and a primary amine, or a mixture of two or more thereof.

In one embodiment, the curing agent is a maleated (also referred to as maleic anhydride-modified) polyolefin, such as maleated polybutadiene or maleated polyisoprene. In other embodiments, the curing agent is a maleated polybutadiene-styrene copolymer, such as maleated SBR.

The ratio of curing agent to epoxy ratio typically used is in the range from about 1:2 to about 2:1 when polyamide-amine curing agents are used. Non-polyamide-amine curing agents are typically used at a ratio of about 1:1 curing agent to epoxy. Examples of curing agents include a polyamide, amidoamine, aliphatic amine, cycloaliphatic amine, dicyandiamide, urea, imidazole or a mixture of two or more thereof. Additional exemplary curing agents are disclosed below.

In one embodiment, the epoxy curative is a polyamide resin. The polyamide may be substituted or unsubstituted. Typically the polyamide is an amine terminated polyamide. A suitable polyamide resin in UNI-REZ® 2115, available from Arizona Chemical, Panama City, Fla.

In another embodiment, the epoxy curative is EPI-CURE® 3115, available from Resolution Performance Products, Houston, Tex. In one embodiment, the epoxy curative is diethylene triamine. In one embodiment, the epoxy curative is a cycloaliphatic amine. In one embodiment, the epoxy curative is a modified aliphatic amine. In one embodiment, the epoxy curative is an amide/imidazoline. In one embodiment, the epoxy curative is an amine terminated polyoxypropylene. Any epoxy curative known in the art may be used, so long as the formulation remains flowable until it is applied.

In another embodiment, the epoxy curative is a cycloaliphatic or heterocycloaliphatic polyamine containing at least two primary amino groups, such as those disclosed in U.S. Pat. No. 5,274,054. As disclosed in U.S. Pat. No. 5,274,054, representative examples of cycloaliphatic amines include

1,2- and 1,4-diaminocyclohexane, bis(4-aminocyclohexyl)methane, bis(4-amino-3-methylcyclohexyl)methane, 2,2-bis(4-aminocyclohexyl)propane, 3-aminomethyl-3,5,5-trimethylcyclohexylamine (isophoronediamine), bis(4-amino-3,5-dimethylcyclohexyl)methane and 1,3-bis(aminomethyl)cyclohexane, and representative examples of heterocycloaliphatic polyamines include

4-amino-3-aminomethyl-1-cyclohexylpiperidine, 4-amino-3-aminomethyl-1-benzylpiperidine, 2-[4-(1,7-diaminoheptyl)]-5,5-dimethyl-1,3-dioxane, 4-amino-3-aminomethyl-1-(3-dimethylaminopropyl)piperidine, 3-amino-4-aminomethyl-1-(3-dimethylaminopropyl)-2-methylpyrrolidine, 3-amino-4-aminomethyl-1,2,2-trimethylpyrrolidine, 3-amino-4-aminomethyl-1-cyclohexyl-2,2-dimethylpyrrolidine, and 3-amino-4-aminomethyl-2-phenyl-1,2-dimethylpyrrolidine.

In another embodiment, the epoxy curative is a polyepoxypropylene diureide such as described in U.S. Pat. No. 4,766,186. The polyepoxypropylene diureides described in U.S. Pat. No. 4,766,186 have a molecular weight in the range from about 2000 to about 3000 and have a general formula:

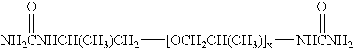

in which x is in the range from about 10 to about 50. A diureide in which x is about 33 is available commercially as JEFFAMINE® BuD-2000, available from Huntsman Corp., Houston, Tex. Polyoxyalkyleneamines, such as other JEFFAMINE® products, may also be used as the epoxy curative agent in the present invention.

In another embodiment, the curative agent is a polythiol compound. Polythiol epoxy curing agents are disclosed, for example, in U.S. Pat. Nos. 6,153,719 and 5,374,668. Exemplary thiols disclosed in U.S. Pat. No. 6,153,719 include aliphatic thiols such as methanedithiol, propanedithiol, cyclohexanedithiol, 2-mercaptoethyl-2,3-dimercaptosuccinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethylene glycol dithioglycolate, trimethylolpropane tris(.beta.-thiopropionate), tris-mercaptan derivative of tri-glycidyl ether of propoxylated alkane, and dipentaerythritol poly(β-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl) isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl) disulfide, hydroxyalkylsulfidebis(mercaptopropionate), hydroxyalkylsulfidebis(mercaptoacetate), mercaptoethyl ether bis(mercaptopropionate), 1,4-dithia-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol. Additional thiol compounds which may be useful as the epoxy curative are disclosed in U.S. Pat. No. 5,374,668.

Cyclic Anhydride and Primary Amine Two-Part Curable Adhesives

In one embodiment, the two-part curable adhesive is an adduct of a cyclic anhydride and a primary amine. In one embodiment, the anhydride is a dianhydride, and in another, the anhydride is a polyanhydride. In one embodiment, the amine is a diamine, and in another, the amine is a polyamine.

Suitable anhydrides include, for example, terephthalic anhydride, naphthalic anhydride; pyromellitic dianhydride; 2,3,6,7-naphthalene tetracarboxylic dianhydride; 3,3′,4,4′-diphenyl tetracarboxylic dianhydride; 1,2,5,6-naphthalene tetracarboxylic dianhydride; 2,2′,3,3′-diphenyl tetracarboxylic dianhydride; 2,2-bis(3,4-dicarboxyphenyl) propane dianhydride; bis(3,4-dicarboxyphenyl) sulfone dianhydride; 3,4,9,10-perylene tetracarboxylic dianhydride; bis(3,4-dicarboxyphenyl) ether dianhydride; naphthalene-1,2,4,5-tetracarboxylic dianhydride; naphthalene-1,4,5,8-tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-1,8,9,10-tetracarboxylic dianhydride; 2,2-bis(2,3-dicarboxyphenyl) propane dianhydride; 1,1-bis(2,3-dicarboxyphenyl) ethane dianhydride; 1,1-bis(3,4-dicarboxyphenyl) ethane dianhydride; bis(2,3-dicarboxyphenyl) methane dianhydride; bis(3,4-dicarboxyphenyl) methane dianhydride; bis (3,4-dicarboxyphenyl) sulfone dianhydride; benzene-1,2,3,4-tetracarboxylic dianhydride; 3,4,3′,4′-benzophenone tetracarboxylic dianhydride; 2,3,2′,3′-benzophenone tetracarboxylic dianhydride; 2,3,3′,4′-benzophenone tetracarboxylic dianhydride; pyrazine-2,3,5,6-tetracarboxylic dianhydride; thiophene-2,3,4,5-tetracarboxylic dianhydride, similar dianhydrides, and mixtures of two or more of the foregoing.

In one embodiment, the cyclic anhydride is a maleated (also referred to as maleic anhydride-modified) polyolefin, such as maleated polybutadiene or maleated polyisoprene. In other embodiments, the cyclic anhydride is a maleated polybutadiene-styrene copolymer, such as maleated SBR.

Suitable amines include, for example, methylene dianiline, meta-phenylene diamine, paraphenylene diamine, 4,4′-diaminodiphenyl sulfone, 3,3′-diaminodiphenyl sulfone, 4,4′-diaminodiphenyl oxide, 2,4 diaminotoluene, 3,3′ diaminodiphenyl methane, 1,3 diamino propane, 1,4 diamino butane, 1,6-diamino hexane, 1,8-diamino octane, 1,12 diamino dodecane and mixtures of two or more thereof. Other suitable amines are disclosed, for example, in U.S. Pat. No. 3,310,506, the disclosure of which is incorporated by reference for its teaching of diamines. Suitable amines also include those defined below with respect to the isocyanate/amine embodiments.

The anhydride and the amine are combined under suitable conditions, at an approximately stoichiometric ratio between the anhydride moieties and the amine moieties.

Oxazoline and Amine, Carboxylic Acid or Anhydride Two-Part Curable Adhesives

In one embodiment, the two-part curable adhesives comprise an oxazoline and an amine, a carboxylic acid or a carboxylic anhydride or a mixture of two or more thereof. Suitable amines include those identified above with respect to the anhydride/amine and epoxy/amine embodiments, and those defined below with respect to the isocyanate/amine embodiments. Suitable carboxylic acids or anhydrides include those anhydrides identified above with respect to the anhydride/amine adhesive embodiments, and the corresponding carboxylic acids, and mixtures thereof. In addition, the carboxylic acids which can be used include dicarboxylic acids having the general formula:

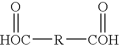

wherein R is a saturated or unsaturated aliphatic or an aromatic moiety having from 2 to about 30 carbon atoms. In one embodiment, when R is aliphatic, it may have from 2 to about 12 carbon atoms. In one embodiment, when R is aromatic, it may have from 6 to about 28 carbon atoms. Exemplary aromatic dicarboxylic acids include phthalic, isophthalic, terephthalic, uritic and cumidimic acids. An exemplary alicyclic dicarboxylic acid is hexahydrophthalic anhydride.

Suitable, exemplary oxazoline compounds include: 4,4′,5,5′-tetrahydro-2,2′-bisoxazole; a 2,2′-(alkanediyl) bis [4,5-dihydrooxazole], e.g., 2,2′-(1,4-butanediyl) bis [4,5-dihydrooxazole]; and 2,2′-(1-methyl-1,3-propanediyl) bis (4,5-dihydrooxazole); a 2,2′-(arylene) bis [4,5-dihydrooxazole], e.g., 2,2′-(1,4-phenylene) bis [4,5-dihydrooxazole], 2,2′(1,5-naphthalenyl) bis [4,5-dihydrooxazole] and 2,2′-(1,8-anthracenyl) bis [4,5-dihydrooxazole]; and alkylene bis 2-(arylene) [4,5-dihydrooxazole], e.g., methylene bis 2-(1,4-phenylene) [4,5-dihydrooxazole]; a 2,2′,2″-(arylene) tris [4,5-dihydrooxazole], e.g., 2,2′,2″-(1,3,5-phenylene) tris[4,5-dihydrooxazole]; oligomeric materials with pendent oxazoline groups such as poly [2-(alkenyl) 4,5-hydrooxazole], e.g., poly [2-(2-propenyl) 4,5-dihydrooxazole], and mixtures of two or more thereof.

The oxazoline and the carboxylic acid are combined under suitable conditions, at an approximately stoichiometric ratio between the acid moieties and the oxazoline moieties.

Carbodiimide and Primary Amine or Carboxylic Acid Two-Part Curable Adhesives

In one embodiment, the two-part curable adhesive comprises a carbodiimide and a primary amine or a carboxylic acid, or a mixture of two or more thereof. In one embodiment, the primary amine is a diamine, and in one embodiment the primary amine is a polyamine. Suitable amines include those identified above with respect to the anhydride/amine and epoxy/amine embodiments, and those defined below with respect to the isocyanate/amine embodiments. Suitable carboxylic acids include those acids identified above with respect to the epoxide/acid and oxazoline/acid embodiments, and mixtures thereof.

Suitable carbodiimides include those having the general structural formula of

R—N═C═N—R′

and

R—N═C═N—[R—N═C═N]ₓ—R′

wherein R and R′ are independently a substituted or unsubstituted, branched or unbranched aliphatic or aromatic hydrocarbyl group and x=1 to about 100. The substitution may include any suitably selected substituent which does not interfere in the adhesive curing reaction. Suitable substituents include C₁-C₃₀ branched or unbranched alkyl, C₆-C₁₈ aromatic, halo (fluoro- chloro-, bromo-, iodo-, etc); nitro; etc.

Suitable primary diamines include those diamines disclosed above in the cyclic anhydride/amine and epoxy/amine embodiments, and include, for example, C₁-C₃₀ branched or unbranched alkyl or polyalkyleneoxy diamines, C₆-C₁₈ aromatic diamines, and may also include those defined below with respect to the isocyanate/amine embodiments.

The reaction between the carbodiimide and carboxylic acid may be generalized as follows:

R—N═C═N—R′+HOOC—R″→R—NH—CO—R″+R′—N═C═O

The reaction between the carbodiimide and the primary amine may be generalized as follows:

R—N═C═N—R′+H₂N—R″→R—N═C(NHR′)—NH—R″

The carbodiimide and the amine are combined under suitable conditions, at an approximately stoichiometric ratio between the imide moieties and the amine moieties.

Isocyanate+Amine, Carboxylic Acid or Alcohol Two-Part Curable Adhesives

In one embodiment, the two-part curable adhesives comprise an isocyanate component and an active hydrogen component comprising one or more of a primary amine, a carboxylic acid or an alcohol. These components react to form polymers such as polyurethanes, polyureas, polyamides, or derivatives thereof. In one embodiment, the active hydrogen compound is a di- or poly-compound, e.g., a diamine or a polyamine, a diacid or a polyacid, or a diol or a polyol.

Suitable isocyanate components include compounds corresponding to the following formula:

Q(NCO)ₙ,

wherein n=2-4, and Q denotes an aliphatic hydrocarbon group having 2 to about 18, in one embodiment about 6 to about 10, carbon atoms, a cycloaliphatic hydrocarbon group having from 4 to about 15, in one embodiment from about 5 to about 10 carbon atoms, an aromatic hydrocarbon group having from 6 to about 18, in one embodiment from 6 to about 13 carbon atoms, or an araliphatic hydrocarbon group having from about 8 to about 15, in one embodiment from about 8 to about 13 carbon atoms.

The following polyisocyanates are exemplary:

hexamethylenediisocyanate, 1,12-dodecanediisocyanate, cyclobutane-1,3-diisocyanate, cyclohexane-1,3- and -1,4-diisocyanate and any mixtures of these isomers,

1-isocyanato-3,3,5-trimethyl-5-isocyanato-methylcyclohexane, hexahydro-1,3-and/or -1,4-phenylene diisocyanate, perhydro-2,4′- and/or -4,4′-diphenylmethane diisocyanate, 1,3- and 1,4-phenylene diisocyanate, 2,4- and 2,6-tolylene diisocyanate and any mixtures of these isomers, diphenylmethane-2,4′- and/or 4,4′-diisocyanate, naphthylene-1,5-diisocyanate, triphenylmethane-4,4′4″-tri-isocyanate and polyphenyl-polymethylene polyisocyanates obtainable by aniline/formaldehyde condensation followed by phosgenation.

There can also be employed relatively high molecular weight polyisocyanates which can be modification products of such simple polyisocyanates. Examples thereof include polyisocyanates containing isocyanurate, carbodiimide, allophanate, biuret or uretdione structural units as obtainable by processes known in the art from the simple polyisocyanates of the above general formula mentioned above. Among the relatively high molecular weight modified polyisocyanates, the prepolymers with isocyanate end groups in the molecular weight range of from about 400 to about 10,000, in one embodiment from about 600 to about 8,000, in another embodiment from about 800 to about 5,000, known from polyurethane chemistry are of particular interest. These compounds are prepared in known manner by the reaction of excess quantities of simple polyisocyanates of the type exemplified above with organic compounds having at least two isocyanate reactive groups, in particular organic polyhydroxyl compounds. Suitable polyhydroxyl compounds of this type include both simple polyhydric alcohols in the molecular weight range of from 62 to 599, or from 62 to 200, e.g. ethylene glycol, trimethylolpropane, propane-1,2-diol, butane-1,4-diol or butane-2,3-diol. Particularly suitable are relatively high molecular weight polyether polyols and/or polyester polyols of the type known per se from polyurethane chemistry which have molecular weights of from 600 to 8000, or from 800 to 4000, and contain at least 2, generally 2 to 8, or 2 to 4 primary and/or secondary hydroxyl groups. Isocyanate prepolymers obtained, for example, from low molecular weight polyisocyanates of the type exemplified above and less preferred compounds containing isocyanate reactive groups, e.g. polythioether polyols, polyacetals containing hydroxyl groups, polyhydroxy-polycarbonates, polyester amides containing hydroxyl groups or hydroxyl group-containing copolymers of olefinically unsaturated compounds may, of course, also be used. For the preparation of the isocyanate prepolymers, these compounds containing isocyanate reactive groups are reacted with simple polyisocyanates of the type exemplified above in proportions corresponding to an NCO/OH equivalent ratio of about 1.5:1 to 20:1, or from 5:1 to 15:1. The isocyanate prepolymers generally have an isocyanate content of from 2.5 to 25, or from 6 to 22% by weight.

Suitable amines include those identified above with respect to the anhydride/amine and epoxy/amine embodiments, and those defined in the following. Suitable amines further include aliphatic, aromatic and aryl-aliphatic diamines and polyamines having a molecular weight of from about 60 to about 300. In one embodiment, diamines such as 1,4-diaminobenzene, 2,4-diaminotoluene, 2,4′- and/or 4,4′-diaminodiphenylmethane or, aromatic polyamines having an alkyl substituent in at least one ortho-position to the amino groups, in particular aromatic diamines having at least one alkyl substituent in an ortho-position to the first amino group and two alkyl substituents, each with 1 to 3 carbon atoms, in an ortho-position to the second amino group are useful. In one embodiment, the aromatic amine has an ethyl, n-propyl and/or isopropyl substituent in at least one ortho-position to the amino groups and optionally methyl substituents in other ortho-positions to the amino groups. Such aromatic diamines include 2,4-diaminomesitylene, 1,3,5-triethyl-2,4-diaminobenzene, 1,3,5-triisopropyl-2,4-diaminobenzene, 1-methyl-3,5-diethyl-2,4-diaminobenzene, commercial mixtures thereof with 1-methyl-3,5-diethyl-2,6-diaminobenzene, 4,6-dimethyl-2-ethyl-1,3-diaminobenzene, 3,5,3′, 5′-tetraethyl-4,4′-diaminodiphenylmethane, 3,5,3′, 5′-tetraisopropyl-4,4′-diaminodiphenylmethane and 3,5-diethyl-3′,5′-diisopropyl-4,4′-diaminodiphenylmethane, and mixtures of such aromatic diamines may also be used. In addition, isophorone diamine, bis-(4-aminocyclohexyl)-methane, 1,4-diaminocyclohexane, ethylenediamine and its homologues and piperazine are useful, as are mixtures of these or mixtures of these and the above aromatic amines.

In one embodiment, the isocyanate group is reacted with low molecular weight, saturated or unsaturated polyhydric alcohols having a molecular weight range of from about 62 to about 400. The saturated alcohols may include ethylene glycol, diethylene glycol, 1,4-dihydroxybutane, butanediol-(2,3), 1,6-dihydroxyhexane, trimethylolpropane, glycerol, pentaerythritol, sorbitol and saccharose. Higher alkyl diols, triols and higher hydroxyl functionality may also be used. The unsaturated alcohols may contain C—C double bonds and/or C—C triple bonds, examples being 3-butenediol-(1,2) and 2-butynediol-(1,4). The unsaturated alcohols may be liquid or solid at room temperature. Diols having a symmetrical structure, such as cis-2-butenediol-(1,4); trans-2-butenediol-(1,4); 2-butynediol-(1,4); and 3-hexenediol-(2,5) are particularly usefulunsaturated alcohols. Mixtures of these compounds may also be used.

Suitable carboxylic acids include any of those disclosed hereinabove (including the anhydrides) for use with any of the two-part curable adhesive compositions described above.

The isocyanate and the amine, carboxylic acid or alcohol are combined under suitable conditions, at an approximately stoichiometric ratio between the isocyanate moieties and the respective amine, carboxylic acid or alcohol moieties.

Tackifier/plasticizer

The two-part curable adhesives of the present invention may further include a tackifier or plasticizer. Liquid tackifiers may also be plasticizers. Thus, the tackifier may be referred to as a tackifier/plasticizer herein. The presence of the tackifier/plasticizer provides for improved initial adhesion when the polymer facestock, with the adhesive applied thereto, is placed on the substrate to be labeled. Suitable tackifier/plasticizers include solid tackifying resins, liquid tackifiers (which may also be referred to as plasticizers), antioxidants, fillers, pigments, waxes, etc. The adhesive materials may contain a blend of solid tackifying resins and liquid tackifying resins (or liquid plasticizers).

It is noted that, in an embodiment in which the label is a clear film label, a clear adhesive is required. In such an embodiment, blends of the adhesive with additives such as tackifiers and plasticizers must produce a clear adhesive product, i.e., when cured and in place on the substrate. In one such embodiment, a liquid tackifiers such as Wingtack 10 from Goodyear Chemical Co. may be employed.

The tackifying resins include those aliphatic hydrocarbon resins made from the polymerization of a feed stream consisting mainly of unsaturated species containing 4 to 6 carbon atoms; rosin esters and rosin acids; mixed aliphatic/aromatic tackifying resins; polyterpene tackifiers; and hydrogenated tackifying resins. The hydrogenated resins can include resins made from the polymerization and subsequent hydrogenation of a feedstock consisting mostly of dicyclopentadiene; resins produced from the polymerization and subsequent hydrogenation of pure aromatic feedstocks such as styrene, alpha-methyl styrene, vinyl toluene; resins fashioned from the polymerization and subsequent hydrogenation of an unsaturated aromatic feedstream wherein the feedstream mainly contains species having from about 7 to about 10 carbon atoms; hydrogenated polyterpene resins; and hydrogenated aliphatic and aliphatic/aromatic resins. Useful tackifying resins include the aliphatic hydrocarbon resins and the hydrogenated resins. Specific examples include rosin acids, rosin esters, styrenated terpene resins, oil-soluble phenolics, and polyterpenes. Commercially available tackifying resins include ESCOREZ® 1310 from Exxon Chemical Co., WlNGTACK® Plus, WINGTACK® 10 and WINGTACK® 95 available from Goodyear Chemical Co., HERCOLYN® D from Hercules, Inc., and ZONAREZ® A-25 from Arizona Chemical Co. The tackifying resin component may comprise about 5% to about 60% by weight of the pressure sensitive adhesive material, and in one embodiment about 10% to about 40% by weight.

The liquid plasticizers suitable for use in the adhesive compositions of this invention include naphthenic oils, paraffinic oils, aromatic oils, and mineral oils. Exemplary plasticizing liquids include naphthenic oils and slightly aromatic oils. The oils when used may be used in about the same relative percentages as the liquid resins in combination with the solid tackifying resin. In one embodiment, the adhesive is tackified with solid tackifying resin and/or with liquid plasticizer and/or liquid resin of the above-described preferred types.

The two-part curable adhesives disclosed herein may have a pot life in the range from about 30 minutes to about 12 hours. The pot life should be long enough so that interruptions in the labeling operation do not result in blocked parts, filled with cured adhesive. In one embodiment, the adhesives disclosed herein may have a pot life in the range from about 1 hour to about 8 hours. In another embodiment, the adhesives disclosed herein may have a pot life in the range from about 2 hours to about 6 hours. As will be recognized, it is advantageous to combine the components of the adhesive as close as possible to the point at which the adhesive will be applied to the polymeric facestock and/or substrate.

### Additional Components

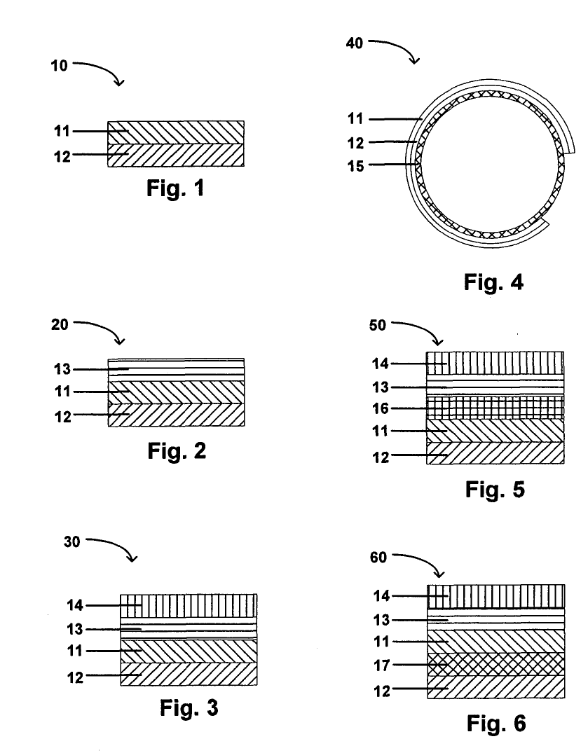

Although not shown in FIGS. 1-5, the labels of the present invention may also contain a layer of an ink-receptive composition on the polymer facestock 11 which enhances the printability of the polymer facestock layer, and the quality of the print layer thus obtained. A variety of such compositions are known in the art, and these compositions generally include a binder and a pigment, such as silica or talc, dispersed in the binder. The presence of the pigment decreases the drying time of some inks. A number of such ink-receptive compositions is described in U.S. Pat. No. 6,153,288 (Shih et al) and the disclosure of this patent is hereby incorporated by reference.

The labels of the present invention may, and generally do, comprise one or more print layers. In one embodiment, illustrated in FIGS. 2 and 3, a print layer 13 is adhered to the upper surface of the polymer facestock 11.

The print layer may be an ink or graphics layer, and the print layer may be a mono-colored or multi-colored print layer depending on the printed message and/or the intended pictorial design. These include, variable imprinted data such as serial numbers, bar codes, trademarks, etc. The thickness of the print layer is typically in the range of about 0.5 to about 10 microns, and in one embodiment about 1 to about 5 microns, and in another embodiment about 3 microns. The inks used in the print layer include commercially available water-based, solvent-based or radiation-curable inks. Examples of these inks include Sun Sheen (a product of Sun Chemical identified as an alcohol dilutable polyamide ink), SUNTEX® MP (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink).

In one embodiment, the print layer comprises a polyester/vinyl ink, a polyamide ink, an acrylic ink and/or a polyester ink. The print layer is formed in the conventional manner by depositing, by gravure printing or the like, an ink composition comprising a resin of the type described above, a suitable pigment or dye and one or more suitable volatile solvents onto one or more desired areas of the polymer facestock layer. After application of the ink composition, the volatile solvent component(s) of the ink composition evaporate(s), leaving only the non-volatile ink components to form the print layer. An example of a suitable resin for use in forming a polyester ink is VITEL® 2700 (Shell Chemical Company, Akron, Ohio)—a copolyester resin having a high tensile strength (7000 psi) and a low elongation (4% elongation). A VITEL® 2700-based polyester ink composition may comprise 18% VITEL® 2700, 6% pigment, 30.4% n-propyl acetate (NP Ac) and 45.6% toluene. As can readily be appreciated, VITEL® 2700 is, by no means, the only polyester resin that may be used to formulate a polyester ink, and solvent systems, other than an NP Ac/toluene system, may be suitable for use with VITEL® 2700, as well as with other polyester resins. An example of a polyester adhesive composition comprises 10.70%, by weight, VITEL® 2300 polyester resin; 10.70%, by weight, VITEL® 2700 polyester resin; 1.1%, by weight, BENZOFLEX S404 plasticizer; 1.1%, by weight, HULS 512 adhesion promoter; 19.20%, by weight, toluene; and 57.10%, by weight, methyl ethyl ketone.

The adhesion of the ink to the surface of the polymer facestock layer 11 can be improved, if necessary, by techniques well known to those skilled in the art. For example, as mentioned above, an ink primer or other ink adhesion promoter can be applied to the polymer facestock layer 11 before application of the ink.

Useful ink primers may be transparent or opaque and the primers may be solvent based or water-based. In one embodiment, the primers are radiation curable (e.g., UV). The ink primer is typically comprised of a lacquer and a diluent. The lacquer is typically comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include alcohols such as ethanol, isopropanol and butanol; esters such as ethyl acetate, propyl acetate and butyl acetate; aromatic hydrocarbons such as toluene and xylene; ketones such as acetone and methyl ethyl ketone; aliphatic hydrocarbons such as heptane; and mixtures thereof. The ratio of lacquer to diluent is dependent on the viscosity required for application of the ink primer, the selection of such viscosity being within the skill of the art. An example of a ink primer material that can be used is CLB04275F-Prokote Primer (a product of Sun Chemical Corporation identified as a solvent based primer useful with inks and coatings). The ink primer layer may have a thickness of from about 1 to about 4 microns or from about 1.5 to about 3 microns.

A transparent protective polymeric topcoat or overcoat layer, which may also be known as an “overprint varnish”, may be present in the labels of the invention. In the embodiment illustrated in FIG. 3, a transparent protective topcoat or overcoat layer 14 overlies the print layer 13. The transparent protective topcoat or overcoat layer 14 provides desirable properties to the label before and after the label is affixed to a substrate such as a container. The presence of a transparent protective layer over the print layer may, in some embodiments, provide additional properties such as antistatic properties, stiffness and/or weatherability, and the transparent protective layer may protect the print layer from, e.g., weather, sun, abrasion, moisture, water, etc. The transparent protective layer can enhance the properties of the underlying print layer to provide a glossier and richer image. The transparent protective layer 14 may also be designed to be abrasion resistant, radiation resistant (e.g, UV), chemically resistant, thermally resistant thereby protecting the label and, particularly the print layer from degradation from such causes. The transparent protective layer 14 may also contain antistatic agents, or anti-block agents to provide for easier handling when the labels are being applied to containers at high speeds. The transparent protective layer 14 constructions of the labels used in the invention may also be selected to provide labels useful on containers subjected to subsequent liquid processing such as bottle washing/rinsing, filling and pasteurization, or liquid immersion (e.g., ice bath) without displaying adverse consequences such as label lifting or hazing. The transparent protective layer 14 may be applied to the print layer by techniques known to those skilled in the art. The transparent protective layer 14 may be deposited from a solution, applied as a preformed film (laminated to the print layer), etc.

Suitable antistatic agents may include any known antistatic agent. In one embodiment, the antistatic agent is added as an antistatic concentrate. In one embodiment, a suitable antistatic concentrate is manufactured by A. Schulman Inc. of Akron, Ohio under the product name POLYBATCH® VLA SF. POLYBATCH® VLA SF is a specialty antistatic concentrate. The POLYBATCH® VLA SF material has the following material properties (which are based on its technical data sheet): melt index of the concentrate of 11-18 grams/10 minutes; and moisture retention (Karl Fisher@190° C.) of 1000 ppm maximum. In another embodiment, the antistatic layer may comprise a polymer having an antistatic additive such as an amine or an amide or a derivative of a fatty acid. In one embodiment, the antistatic agent is present in the polymer in an amount sufficient to provide from about 0.1% to about 5% by weight of the coating. Exemplary of a suitable commercially available antistatic agent is a quaternary ammonium chloride derivative of poly-alkoxy tertiary amine manufactured by WITCO Corporation and sold under the designation MARKSTAT® AL-12. Other suitable antistatic materials are known in the art.

When a transparent topcoat or overcoat layer 14 is present, it may have a single layer or a multilayered structure. The thickness of the protective layer is generally in the range of about 0.5 to about 5 mils, and in one embodiment about 1 to about 3 mils. Examples of the topcoat layers are described in U. S. Pat. No. 6,106,982, which is incorporated herein by reference for its teachings relating to topcoat layers.

The transparent protective layer 14 may comprise any of polyurethanes, polyacryls, polymethacryls, thermoplastic polymers of ethylene and propylene, ionomers, polyesters, polyamides, polyvinyl alcohols, polyvinyl pyrrolidinones, polyacrylonitriles, polycarbonates, polyolefins, rubbers, vinyl acetate homopolymers and co- or terpolymers, polystyrenes and combinations and blends of two or more thereof.

The transparent protective layer 14 may contain UV light absorbers and/or other light stabilizers. Among the UV light absorbers that are useful are the hindered amine absorbers available from Ciba-Geigy under the trademark TINUVIN®. The light stabilizers that can be used include the hindered amine light stabilizers available from Ciba-Geigy under the trade designations TINUVIN® 111, TINUVIN® 123, (bis-(1-octyloxy-2,2,6,6-tetramethyl-4-piperidinyl) sebacate; TINUVIN® 622, (a dimethyl succinate polymer with 4-hydroxy-2,2,6,6-tetramethyl-1-piperidinethanol); TINUVIN® 770 (bis-(2,2,6,6-tetramethyl-4-piperidinyl)-sebacate); and TINUVIN® 783. Also useful light stabilizers are the hindered amine light stabilizers available from Ciba-Geigy under the trade designation “Chemassorb”, especially Chemassorb 119 and Chemassorb 944. The concentration of the UV light absorber and/or light stabilizer is in the range of up to about 2.5% by weight, and in one embodiment about 0.05% to about 1% by weight.

The transparent protective layer 14 may contain an antioxidant. Any antioxidant useful in making thermoplastic films can be used. These include the hindered phenols and the organophosphites. Examples include those available from Ciba-Geigy under the trade designations IRGANOX® 1010, IRGANOX® 1076 or IRGAFOS® 168. The concentration of the antioxidant in the thermoplastic film composition may be in the range of up to about 2.5% by weight, and in one embodiment about 0.05% to about 1% by weight.

The transparent protective layer 14 may contain a UV absorbent material. In one embodiment, the UV absorbent material comprises an adhesion-promoting material. In one embodiment, the transparent protective layer includes a UV absorbent and adhesion-promoting material which contains acrylic/epoxy functionality. In one embodiment, when the UV absorbent and adhesion-promoting material containing acrylic/epoxy functionality is applied, only the acrylic portion of the material reacts with the polymer facestock to form the adhesion thereto. This leaves the epoxy groups unreacted, and thereby available for further reaction with, e.g., the two-part curable adhesive to be later applied in accordance with the present invention. One such combined UV absorbent and adhesion-promoting material which contains acrylic/epoxy functionality is UVACURE® 1562, which is available from UCB Radcure of Smyrna, Ga. Another such combined UV absorbent and adhesion-promoting material which contains acrylic/epoxy functionality is UVACURE® 1561, which also is available from UCB Radcure.

The transparent protective layer 14 or the layer 17 may contain a metal deactivator. Any metal deactivator useful in making thermoplastic films can be used. These include the hindered phenol metal deactivators. Examples include those available from Ciba-Geigy under the trade designation IRGANOX® 1024. The concentration of the metal deactivator in the thermoplastic film composition is in the range of up to about 1% by weight, and in one embodiment about 0.2% to about 0.5% by weight.

In a second embodiment, the present invention relates to a label applied to a substrate. The second embodiment includes a labeled substrate, including:

(A) a substrate having an outer surface;

(B) a adhesive layer derived from a two-part, high solids curable adhesive having a first surface and a second surface, wherein the first surface overlies the outer surface of the substrate; and

(C) a polymeric label adhered to the second surface of the adhesive.

The substrate may be any suitable substrate, as described above.

FIG. 4 is a schematic cross-sectional view of a label 40 applied to a substrate 15 in accordance with this embodiment of the present invention. The label 40 includes the polymer facestock 11 and the two-part curable adhesive, in accordance with the present invention. In the embodiment shown in FIG. 4, the substrate 15 is depicted as a round object, but it may have any cross-sectional shape, consistent with being able to receive a label. Any of the labels described in the following may be applied to the substrate 15, in accordance with the present invention. Although not shown, the label 40 may further include any or all of the print layer 13, the transparent protective layer 14, or the antistatic layer 16 described below.

FIG. 5 illustrates a label 50 which comprises a polymer facestock 11 having an upper surface and a lower surface; a two-part curable adhesive layer 12 having an upper surface and a lower surface wherein the upper surface of the two-part curable adhesive layer 12 is in contact with the lower surface of the polymer facestock 11; a print layer 13 which overlies and is in contact with the upper surface of the polymer facestock 11; and a transparent protective layer 14 which overlies and is in contact with the upper surface of the print layer 13. The previous discussion of the print layer 13 and the transparent protective layer 14 with respect to the first embodiment applies completely to the print layer 13 and the transparent protective layer 14 in the label 50 of FIG. 5. In addition, the label 50 shown in FIG. 5 includes an additional antistatic polymer layer 16 between the polymer facestock layer 11 and the print layer 13. The antistatic polymer layer 16 may comprise any of the antistatic protective compositions described above.

FIG. 6 illustrates a label 60 which comprises a polymer facestock 11 having an upper surface and a lower surface; a two-part curable adhesive layer 12 having an upper surface and a lower surface wherein the upper surface of the two-part curable adhesive layer 12 is separated from the lower surface of the polymer facestock 11 by a barrier or tie layer 17; a print layer 13 which overlies and is in contact with the upper surface of the polymer facestock 11; and a transparent protective layer 14 which overlies and is in contact with the upper surface of the print layer 13. The previous discussion of the polymer facestock 11, the adhesive layer 12, print layer 13 and the transparent protective layer 14 with respect to the previous embodiments apply completely to these layers in the label 60 of FIG. 6. In addition, the label 60 shown in FIG. 6 includes the additional barrier or tie layer 17 between the facestock layer 11 and the adhesive layer 12. The barrier or tie layer 17 may be a barrier coating and/or a tie coat layer which helps to anchor the upper surface of the adhesive layer 12 to the lower surface of the facestock layer 11.

The barrier layer 17 can reduce the migration of tackifier or plasticizer into the facestock layer 11, in an embodiment in which such components are used in the adhesive layer 12. The barrier layer 17 may also act as a tie coating and not provide barrier properties or it act as both a tie layer coating and a barrier coating at the same time. In one embodiment, the barrier/tie layer 17 functions as both a barrier layer and a tie layer to the adhesive layer 12.

An exemplary barrier layer 17 is based on a UV-cured cycloaliphatic epoxy resin. Such a system is described in U.S. Pat. No. 6,235,363, which is incorporated herein by reference. This cured barrier layer will also have residual epoxy groups available to help tie the adhesive to the facestock containing this barrier coating. This is particularly useful in an embodiment in which the adhesive is an epoxy adhesive, but is also useful in embodiments in which the adhesive includes residual active hydrogens. Thus, in such an embodiment, the barrier/tie layer 17 can function as both a barrier and a tie layer.

In another embodiment, the tie coat/barrier layer 17 comprises an acrylate UV-curable coating containing a dual-functional monomer. An example of such a monomer is UVACURE® 1562. In one embodiment, this monomer is present in the UV curable acrylate formulation at about 10.5% by weight. Another example of such a monomer is UVACURE® 5 1561, which is a partially acrylated glycidyl ether epoxy (bisphenol A epoxy). In one embodiment, this monomer is present in the UV curable acrylate formulation at about 60% by weight. The quantity of the dual-functional monomer in the tie coat/barrier layer 17 may range from about 10% by weight to about 75% by weight. In one embodiment, the quantity of the dual-functional monomer in the tie coat/barrier layer 17 may range from about 40% by weight to about 60% by weight.

In one embodiment, the tie coat layer 17 may comprise another material which includes a reactive component capable of curing with reactive groups present in the adhesive component and in the facestock layer. For example, in the UVACURE® 1561, tie coat layer is formed by UV-activated polymerization of the acrylate groups, and the epoxy groups remain available for reaction with epoxy groups in an epoxy-based room-temperature curable adhesive layer. Thus, for the tie coat layer other functional resins may be used which include groups curable with other of the two-component adhesive compositions. For example, if the two-component adhesive is based on polyamide-amine/epoxy, then the tie coat layer 17 may contain reactive groups such as isocyanate, anhydride, oxazoline and carbodiimide which can react with amine functionality. As will be recognized by those of skill in the art, numerous combinations of groups may be used in the tie coat layer 17.

It is noted that, while the barrier/tie layer 17 is shown in an embodiment including both the print layer 13 and the transparent protective layer 14, that the barrier/tie layer 17 may be used with any of the embodiments described herein.

The labels of the present invention are useful for labeling of plastic, glass or metal containers or surfaces. In one embodiment, the substrate is a beverage container. In another embodiment, the substrate is a beer bottle.

Methods

In a third embodiment, the present invention relates to a method of applying the disclosed at least one two-part curable adhesive-coated polymer facestock labels to a suitable substrate.

The process of applying the label to the substrate generally is one wherein the labels (without adhesive) are provided as a stack in a label magazine. A high solids, curable adhesive composition is provided to a rotating adhesive cylinder. If the adhesive is a two-part composition, in one embodiment, the two parts are mixed shortly (e.g. about 30 seconds to 60 minutes, or about 2 minutes to about 30 minutes, or about 5 minutes to 15 minutes) or immediately before being provided to the rotating adhesive cylinder. A rotating pallet removes the adhesive from the rotating adhesive cylinder and applies the adhesive to the lower surface of the top label in the stack. The label is then transferred to a label transfer drum, on which it is held by means such as vacuum suction and/or grippers. From the transfer drum, the label is applied on its adhesive side to the substrate, e.g., a container. In one embodiment, the adhesive is normally applied to the label at ambient temperature, namely, from about 20° C. to about 30° C.

As noted, conventional labeling systems use a pallet to transfer adhesive from the adhesive cylinder to the label. In conventional systems, the surface of this pallet usually consists of very fine shallow grooves which are continuous across the width. These are designed by the machine builder to aid adhesive pickup. This results in adhesive coverage of at least 75 or 80%, often about 100%. Alternatively, it is possible to provide pallets having a surface configuration chosen in accordance with a pattern of adhesive which is applied to the label. These pallets may be made of conventional materials.

Thus, in one embodiment, the present invention relates to a labeling process comprising the steps of (A) providing a substrate; (B) coating a two-part curable adhesive to one surface of a polymeric facestock; and (C) applying the adhesive coated surface of the polymeric facestock to the substrate. In another embodiment, the present invention further relates to a labeling process, including steps of (A) providing a substrate having an outer surface; (B) providing a polymer facestock having a first surface and a second surface, wherein the polymer facestock is a biaxially oriented polyethylene terephthalate or polypropylene; (C) applying to the first surface of the polymer facestock a layer of an two-part curable adhesive; and (D) applying the first surface of the polymer facestock to the outer surface of the substrate, as a result of which the two-part curable adhesive provides an initial adhesion between the polymer facestock and the outer surface of the substrate.

In one embodiment, the labeling process further includes a step of combining and mixing together the epoxy resin and the curing agent, prior to applying the adhesive to the first surface of the polymer facestock. In one embodiment, the mixing is shortly (described above) or immediately prior to application of the adhesive to the polymer facestock. In one embodiment, the mixing is provided by a screw-extruder, which in turn provides the mixed two-part curable adhesive to an apparatus which spreads the mixed adhesive on the polymeric facestock. In addition to the foregoing, other mixing systems may be employed, such as static mixers or paddle mixers designed for highly viscous curable adhesives. Generally, following (D), the two-part curable adhesive continues to polymerize and increase adhesion between the polymer facestock and the outer surface of the substrate. Since the two-part curable adhesive may not have been mixed until just prior to its application to the polymer facestock, very little time has been allowed for the hardening reaction to take place prior to application of the adhesive. Thus, in one embodiment, the two-part curable adhesive includes a tackifier and/or plasticizer to provide or to improve the initial adhesion of the adhesive.

In one embodiment, a tie coat/barrier layer is applied to the facestock prior to application of the two-part curable adhesive. Thus, in one embodiment, the process further comprises a step of applying a tie coat layer or barrier coat layer to the facestock.

In one embodiment, as disclosed above, the two-part curable adhesive includes (B-1) at least one of a thermoplastic polyurethane modified epoxy resin or an epoxidized cyclohexane dimethanol modified with a CTBN elastomer. In one embodiment, the two-part curable adhesive further comprises (B-2) at least one polyamide resin curing agent

When the labels of the present invention are dispensed with a labeling machine to a glass beer bottle using the two-part curable adhesive, excellent initial adhesion of the label to the bottle is observed. After drying at room temperature for 7 days, the labeled bottles are immersed into ice water, and after 3 days in the ice water, the labels remain bonded to the bottles, and there is no sliding of the label when pressure is applied to the label.

### EXAMPLES

The following examples relate to the labels of the present invention, their preparation and to the substrates to which the labels may be attached. These examples are illustrative and not intended to be limiting in scope.

The materials used in the following Examples are the following:

Substrate: In the following examples, the substrate is a polyethylene wax-coated bottle, which may be, for example, a beer bottle. As noted above, in many instances beverage bottles and other containers, to which the label of the present invention may be applied, are coated with a protective outer layer, such as the above-mentioned polyethylene wax coating. The container is merely exemplary, and the present invention is not limited to use with any particular container. In the examples, the bottle tested is refrigerated overnight. Just prior to use, the bottle is removed from the refrigerator, and a layer of condensation is allowed to form on the surface of the bottle prior to use. This is to simulate application of a label to a bottle which has been filled with a chilled liquid, such as beer, in which some amount of condensation may have formed on the bottle surface.

Facestocks:

PET polymer facestock:

polypropylene polymer facestock, biaxially oriented (BOPP)

The facestock may be coated with an acrylic UV-protective coating containing UVACURE® 1561, an epoxy-acrylate monomer. The facestock with the UV curable acrylate coating containing the Uvacure 1561 is available from UCB Radcure of Smyrna, Ga. When UVACURE® 1561 is cured into the coating, only the acrylate portion of the monomer reacts, leaving free epoxy groups. The free epoxy groups can react with, and provide an anchor for, the two-part curable adhesive which will be applied subsequently to the polymer facestock.

Epoxy-based Adhesive Materials:

ERISYS® EMRM-22, a CTBN Rubber-modified epoxy resin, available from CVC Specialty Chemicals, Maple Shade, N.J.

ERISYS® EMUA-11, a thermoplastic-modified bisphenol A (BPA) epoxy resin, available from CVC Specialty Chemicals, Maple Shade, N.J.

EPI-CURE® 3115, an amine-polyamide resin, available from Resolution Performance Products, Houston, Tex.

UNI-REZ® 2115, an amine-polyamide resin, available from Arizona Chemical, Panama City, Fla.

GE-60 Multi-Epoxy Resin, sorbitol polyglycidyl ether, available from CVC Specialty Chemicals, Maple Shade, N.J. (aliphatic polyfunctional epoxy resin used to crosslink acid functional resins).

UVACURE® 1561, a partially acrylated bisphenol A epoxy resin, available from UCB, Smyrna, Ga.

Other Adhesive Materials:

Ricon R131MA10, maleated-polybutadiene resin (acid functional resin) available from Sartomer Co., Exton, Pa.

Sartomer SR492, propoxylated trimethylolpropane triacrylate, available from Sartomer Co., Exton, Pa.

Sartomer SR9003, propoxylated neopentyl glycol diacrylate, available from Sartomer Co., Exton, Pa.

Other Additives:

Tego Degussa Airex 920, silicone-based defoamer, available from Tego Chemie Service USA, Hopewell, Va.

Tego Degussa KL245, silicone-based wetting agent, available from Tego Chemie Service USA, Hopewell, Va.

Ciba IRGACURE® 500, liquid blend of benzophenone and α-hydroxy ketone photoiniator, available from CIBA Specialty Chemicals, Tarrytown, N.Y.

Application Procedure: The polymer facestock is coated with the two-part curable adhesive by drawing down on the coated side of the facestock with a #3 rod. The label is then applied to a polyethylene-coated bottle such as described above, by rolling the bottle over the wet uncured two-part curable adhesive. This simulates the application of the label in a standard labeling machine.

### Example 1:

Applied to PET polymer facestock.
Formulation:

| Epoxy resin: | EMRM-22 CTBN Rubber-modified epoxy | 53.00 wt % |
|---|---|---|
| | resin | |
| Curing agent: | EPI-CURE ® 3115 amine-polyamide | 47.00 |
| | resin | 100.00 |

Results:

Label does not swim when applied. Very good dry clarity and strong bond after 3 days; label does not peel off.

### Example 2:

Applied to PET polymer facestock.
Formulation:

| Epoxy resin: | EMUA-11 Thermoplastic-modified BPA | 29.25 wt % |
|---|---|---|
| | epoxy resin | |
| Epoxy resin: | EMRM-22 CTBN Rubber-modified epoxy | 29.25 |
| | resin | |
| Curing agent: | EPI-CURE ® 3115 amine-polyamide | 41.50 |
| | resin | 100.00 |

Results:

Label swims slightly upon application. After two days a very strong bond to bottle and glass with some peeling off of label. The PET label actually broke while attempting to peel off the label during testing.

### Example 3:

Applied to PET polymer facestock.
Formulation:

| Epoxy resin: | EMUA-11 Thermoplastic-modified BPA | 73.80 wt % |
|---|---|---|
| | epoxy resin | |
| Curing agent: | EPI-CURE ® 3115 amine-polyamide | 26.20 |
| | resin | |
| | | 100.00 |

Results:

Very little swimming when applied. After two days a fairly strong bond to bottle and glass, adhesive is slightly gummy.

### Example 4:

Applied to both PET and BOPP polymer facestocks.
Formulation:

| Epoxy resin: | EMRM-22 CTBN Rubber-modified | 58.50 wt % |
|---|---|---|
| | epoxy resin | |
| Curing agent: | EPI-CURE ® 3115 amine-polyamide | 41.50 |
| | | 100.00 |

Results:

Very little swimming, much finger pressure needed to obtain any movement. Very good clarity and very strong bond after 2 days. BOPP sample was excellent.

### Example 5:

Applied to both PET and BOPP polymer facestocks.
Formulation:

| Epoxy resin: | EMRM-22 CTBN Rubber-modified | 41.30 wt % |
|---|---|---|
| | epoxy resin | |
| Curing agent: | EPI-CURE ® 3115 amine-polyamide | 58.70 |
| | resin | |
| | | 100.00 |

Results:

After two days, clarity very good with very strong bond to both facestocks.

### Example 6:

Applied to BOPP polymer facestock.
Formulation:

| Epoxy resin: | EMUA-11 Thermoplastic-modified | 31.90 wt % |
|---|---|---|
| | BPA epoxy resin | |
| Epoxy resin: | EMRM-22 CTBN Rubber-modified | 21.30 |
| | epoxy resin | |
| Curing agent: | UNI-REZ ® 2115 amine-polyamide | 46.80 |
| | resin | |
| | | 100.00 |

### Example 7:

Applied to BOPP polymer facestock.
Formulation:

| Base resin: | Sartomer R131MA10 Maleated- | 85.3 wt % |
|---|---|---|
| | Polybutadiene Resin | |
| Curing agent: | GE 60 Multi-Epoxy Resin | 14.70 |
| | | 100.00 |

Results:

After six days a very strong bond to bottle and facestock with good clarity. This system cures somewhat more slowly than the other examples, but speed of cure depends on end-use requirements. This experiment demonstrates that other 100% solids, two-component, room-temperature cure systems are within the scope of the present invention.

### Example 8:

First, to Avery X1090 BOPP polymer facestock was applied a tie
coat/barrier layer at approximately 2 grams per square meter
under nitrogen:

| | |
|---|---|
| SR492 | 11.5% |
| SR9003 | 25.0 |
| UVA-CURE ® 1561 | 60.0 |
| Irgacure 500 | 3.0 |
| KL245 | 0.4 |
| Airex 920 | 0.1 |
| Total | 100.0 |

This mixture was cured by passing the facestock with the tie coat/barrier layer mixture under a Fusion “H” bulb at 100% power at 150 feet per minute (about 45.7 meters/min.).

Adhesive Formulation:

| Base resin: | EPALLOY 5000 | 50.0 wt % |
|---|---|---|
| Curing agent: | EPI-CURE ® 3115 amine-polyamide | 50.0 |
| | resin | |
| | | 100.00 |

The adhesive formulation was applied to the UV cured tie coat/barrier layer and this was affixed to a beer bottle, and aged for 5 days.

Results:

After the aging, the label was then removed from the bottle. The adhesive came off with the label, indicating that the bond between the tie coat/barrier layer and the adhesive was stronger than the bond between the adhesive and the bottle.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A label comprising:
(A) a polymer facestock having an upper surface and a lower surface; and
(B) an adhesive layer derived from at least one two-part, high solids curable adhesive overlying the lower surface of the polymer facestock.

2. The label of claim 1, wherein the adhesive cures without application of an external energy source.

3. The label of claim 1, wherein the two-part curable adhesive further comprises a tackifier or plasticizer, or a mixture thereof.

4. The label of claim 1, wherein the two-part curable adhesive has an initial tack sufficient to remain in a position when applied to a substrate.

5. The label of claim 1, wherein the two-part curable adhesive, when applied to the label, has a viscosity in the range from about 30,000 cps to about 120,000 cps.

6. The label of claim 1, wherein the coat weight of the adhesive layer is from about 5 to about 30 g/m².

7. The label of claim 1, wherein the polymer facestock is a polyester or poly-α-olefin or metallized polyolefin, or polylactic acid polymer.

8. The label of claim 7, wherein the polymer facestock is a biaxially oriented polypropylene or a biaxially oriented polyethylene terephthalate.

9. The label of claim 1, wherein the upper surface of the polymer facestock is corona treated or flame treated.

10. The label of claim 1, further comprising a barrier or tie coating layer between the polymer facestock and the two-part curable adhesive.

11. The label of claim 1, further comprising a print layer overlying the upper surface of the polymer facestock.

12. The label of claim 11, further comprising a transparent protective layer overlying the print layer.

13. The label of claim 11, wherein the protective layer comprises a polyamide, polyurethane, cellulosic polymer, silicone polymer, or any combination thereof.

14. The label of claim 11, further comprising a transparent abrasion, chemical, and/or ultraviolet resistant layer overlying the print layer.

15. The label of claim 11, further comprising an adhesion promoting layer between the upper surface of the polymer facestock and the print layer.

16. The label of claim 11, further comprising a layer of ink receptive composition between the upper surface of the polymer facestock layer and the print layer.

17. The label of claim 1, wherein the adhesive comprises (a) an epoxy resin and a primary amine, a carboxylic acid or a carboxylic anhydride or a mixture of two or more thereof; (b) a cyclic anhydride and a primary amine; (c) an oxazoline and a primary amine, a carboxylic acid or a carboxylic anhydride or a mixture of two or more thereof; (d) a carbodiimide and primary amine or a carboxylic acid; or (e) an isocyanate and a primary amine, an alcohol or a carboxylic acid, or a mixture of two or more thereof; or a mixture of two or more of (a)-(e).

18. The label of claim 1, wherein the two-part curable adhesive comprises at least one epoxy resin which is a diglycidyl ether of a bisphenol, a diglycidyl ether of an aliphatic glycol, an epoxidized olefin, a polymer- or rubber-modified epoxy resin, or a mixture of two or more thereof and an epoxy curing agent.

19. The label of claim 18, wherein the epoxy curing agent is a primary amine, diamine or polyamine or a carboxylic acid, dicarboxylic acid, polycarboxylic acid, or an anhydride of such acid.

20. The label of claim 18, wherein the two-part curable adhesive further comprises a reactive diluent.

21. The label of claim 1, wherein the two-part curable adhesive comprises (b) a cyclic anhydride and a primary amine.

22. The label of claim 21, wherein the cyclic anhydride comprises a maleated polyolefin, terephthalic anhydride, naphthalic anhydride; pyromellitic dianhydride; 2,3,6,7-naphthalene tetracarboxylic dianhydride; 3,3′,4,4′-diphenyl tetracarboxylic dianhydride; 1,2,5,6-naphthalene tetracarboxylic dianhydride; 2,2′,3,3′-diphenyl tetracarboxylic dianhydride; 2,2-bis(3,4-dicarboxyphenyl) propane dianhydride; bis(3,4-dicarboxyphenyl) sulfone dianhydride; 3,4,9,10-perylene tetracarboxylic dianhydride; bis(3,4-dicarboxyphenyl) ether dianhydride; naphthalene-1,2,4,5-tetracarboxylic dianhydride; naphthalene-1,4,5,8-tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-1,8,9,10-tetracarboxylic dianhydride; 2,2-bis(2,3-dicarboxyphenyl) propane dianhydride; 1,1-bis(2,3-dicarboxyphenyl) ethane dianhydride; 1,1-bis(3,4-dicarboxyphenyl) ethane dianhydride; bis(2,3-dicarboxyphenyl) methane dianhydride; bis(3,4-dicarboxyphenyl) methane dianhydride; bis (3,4-dicarboxyphenyl) sulfone dianhydride; benzene-1,2,3,4-tetracarboxylic dianhydride; 3,4,3′,4′-benzophenone tetracarboxylic dianhydride; 2,3,2′,3′-benzophenone tetracarboxylic dianhydride; 2,3,3′,4′-benzophenone tetracarboxylic dianhydride; pyrazine-2,3,5,6-tetracarboxylic dianhydride; thiophene-2,3,4,5-tetracarboxylic dianhydride, similar dianhydrides, and mixtures of two or more of the foregoing.

23. The label of claim 21, wherein the primary amine comprises methylene dianiline, meta-phenylene diamine, paraphenylene diamine, 4,4′-diaminodiphenyl sulfone, 3,3′-diaminodiphenyl sulfone, 4,4′-diaminodiphenyl oxide, 2,4-diaminotoluene, 3,3′-diaminodiphenyl methane, 1,3-diamino propane, 1,4-diamino butane, 1,6-diamino hexane, 1,8-diamino octane, 1,12-diamino dodecane and mixtures of two or more thereof.

24. The label of claim 1, wherein the two-part curable adhesive comprises c) an oxazoline and a primary amine, a carboxylic acid or anhydride or a mixture of two or more thereof.

25. The label of claim 24, wherein the oxazoline comprises 4,4′, 5,5′-tetrahydro-2,2′-bisoxazole; a 2,2′-(alkanediyl) bis [4,5-dihydrooxazole], e.g., 2,2′-(1,4-butanediyl) bis [4,5-dihydrooxazole]; and 2,2′-(1-methyl-1,3-propanediyl) bis (4,5-dihydrooxazole); a 2,2′-(arylene) bis [4,5-dihydrooxazole], e.g., 2,2′-(1,4-phenylene) bis [4,5-dihydrooxazole], 2,2′(1,5-naphthalenyl) bis [4,5-dihydrooxazole] and 2,2′-(1,8-anthracenyl) bis [4,5-dihydrooxazole]; and alkylene bis 2-(arylene) [4,5-dihydrooxazole], e.g., methylene bis 2-(1,4-phenylene) [4,5-dihydrooxazole]; a 2,2′,2″-(arylene) tris [4,5-dihydrooxazole], e.g., 2,2′,2″-(1,3,5-phenylene) tris[4,5-dihydrooxazole]; oligomeric materials with pendent oxazoline groups such as poly [2-(alkenyl) 4,5-hydrooxazole], e.g., poly [2-(2-propenyl) 4,5-dihydrooxazole], and mixtures of two or more thereof.

26. The label of claim 24, wherein the carboxylic acid or cyclic anhydride comprises a maleated polyolefin, terephthalic anhydride, naphthalic anhydride; pyromellitic dianhydride; 2,3,6,7-naphthalene tetracarboxylic dianhydride; 3,3′,4,4′-diphenyl tetracarboxylic dianhydride; 1,2,5,6-naphthalene tetracarboxylic dianhydride; 2,2′,3,3′-diphenyl tetracarboxylic dianhydride; 2,2-bis(3,4-dicarboxyphenyl) propane dianhydride; bis(3,4-dicarboxyphenyl) sulfone dianhydride; 3,4,9,10-perylene tetracarboxylic dianhydride; bis(3,4-dicarboxyphenyl) ether dianhydride; naphthalene-1,2,4,5-tetracarboxylic dianhydride; naphthalene-1,4,5,8-tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-1,8,9,10-tetracarboxylic dianhydride; 2,2-bis(2,3-dicarboxyphenyl) propane dianhydride; 1,1-bis(2,3-dicarboxyphenyl) ethane dianhydride; 1,1-bis(3,4-dicarboxyphenyl) ethane dianhydride; bis(2,3-dicarboxyphenyl) methane dianhydride; bis(3,4-dicarboxyphenyl) methane dianhydride; bis (3,4-dicarboxyphenyl) sulfone dianhydride; benzene-1,2,3,4-tetracarboxylic dianhydride; 3,4,3′,4′-benzophenone tetracarboxylic dianhydride; 2,3,2′,3′-benzophenone tetracarboxylic dianhydride; 2,3,3′,4′-benzophenone tetracarboxylic dianhydride; pyrazine-2,3,5,6-tetracarboxylic dianhydride; thiophene-2,3,4,5-tetracarboxylic dianhydride, the corresponding acids of any of the foregoing anhydrides, and mixtures of two or more of the foregoing.

27. The label of claim 24, wherein the primary amine comprises methylene dianiline, meta-phenylene diamine, paraphenylene diamine, 4,4′-diaminodiphenyl sulfone, 3,3′-diaminodiphenyl sulfone, 4,4′-diaminodiphenyl oxide, 2,4-diaminotoluene, 3,3′-diaminodiphenyl methane, 1,3-diamino propane, 1,4-diamino butane, 1,6-diamino hexane, 1,8-diamino octane, 1,12-diamino dodecane and mixtures of two or more thereof.

28. The label of claim 1, wherein the two-part curable adhesive comprises (d) a carbodiimide and primary amine or a carboxylic acid, or a mixture of two or more thereof.

29. The label of claim 28, wherein the carbodiimide has the general structural formula:
R—N═C═N—R′
or
R—N═C═N—[R—N═C═N]_{X}—R′
wherein R and R′ are independently a substituted or unsubstituted, branched or unbranched aliphatic or aromatic hydrocarbyl group and x=1 to about 100.

30. The label of claim 28, wherein the primary amine comprises methylene dianiline, meta-phenylene diamine, paraphenylene diamine, 4,4′-diaminodiphenyl sulfone, 3,3′-diaminodiphenyl sulfone, 4,4′-diaminodiphenyl oxide, 2,4-diaminotoluene, 3,3′-diaminodiphenyl methane, 1,3-diamino propane, 1,4-diamino butane, 1,6-diamino hexane, 1,8-diamino octane, 1,12-diamino dodecane and mixtures of two or more thereof.

31. The label of claim 28, wherein the carboxylic acid is a dicarboxylic acid having the general formula: 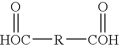
wherein R is a saturated or unsaturated aliphatic or an aromatic moiety having from 2 to about 30 carbon atoms.

32. The label of claim 1, wherein the two-part curable adhesive comprises (e) an isocyanate and a primary amine, an alcohol or a carboxylic acid, or a mixture of two or more thereof.

33. The label of claim 32, wherein the isocyanate is a compound having the following formula:
Q(NCO)ₙ,
wherein n=2-4, and Q denotes an aliphatic hydrocarbon group having 2 to about 18 carbon atoms, a cycloaliphatic hydrocarbon group having from 4 to about 15 carbon atoms, an aromatic hydrocarbon group having from 6 to about 18 carbon atoms, or an aryl-aliphatic hydrocarbon group having from about 8 to about 15 carbon atoms.

34. The label of claim 33, wherein the amine is an aliphatic, aromatic or aryl-aliphatic diamine or polyamine having a molecular weight of from about 60 to about 300.

35. The label of claim 33, wherein the alcohol is a saturated or unsaturated polyhydric alcohol having a molecular weight in the range from about 62 to about 400.

36. The label of claim 33, wherein the carboxylic acid is a dicarboxylic acid having the general formula: 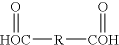
wherein R is a saturated or unsaturated aliphatic or an aromatic moiety having from 2 to about 30 carbon atoms.

37. A label comprising:
(A) a polymer facestock having an upper surface and a lower surface, wherein the polymer facestock is a biaxially oriented polyethylene terephthalate or polypropylene; and
(B) an adhesive layer derived from at least one high solids, curable adhesive composition comprising (a) an epoxy resin and a primary amine, a carboxylic acid or a carboxylic anhydride or a mixture of two or more thereof; (b) a cyclic anhydride and a primary amine; (c) an oxazoline and a primary amine, a carboxylic acid or a carboxylic anhydride or a mixture of two or more thereof; (d) a carbodiimide and primary amine or a carboxylic acid; or (e) an isocyanate and a primary amine, an alcohol or a carboxylic acid, or a mixture of two or more thereof; or a mixture of two or more of (a)-(e).

38. A labeling process comprising the steps of (A) providing a substrate; (B) coating a two-part, high solids curable adhesive to one surface of a polymeric facestock; and (C) applying the adhesive coated surface of the polymeric facestock to the substrate.

39. The labeling process of claim 38, wherein the substrate is glass, plastic or metal.

40. The labeling process of claim 38, wherein the adhesive comprises (a) an epoxy resin and a primary amine, a carboxylic acid or a carboxylic anhydride or a mixture of two or more thereof; (b) a cyclic anhydride and a primary amine; (c) an oxazoline and a primary amine, a carboxylic acid or a carboxylic anhydride or a mixture of two or more thereof; (d) a carbodiimide and primary amine or a carboxylic acid; or (e) an isocyanate and a primary amine, an alcohol or a carboxylic acid, or a mixture of two or more thereof; or a mixture of two or more of (a)-(e).

41. The labeling process of claim 38, wherein the polymer facestock is a biaxially oriented polyethylene terephthalate or polypropylene.
